(19) United States
(12) Patent Application Publication
(10) Pub. No.: US 2003/0017774 A1
(43) Pub. Date: Jan. 23, 2003

(54) Fibrous material and method and treatment liquid for the production thereof

(76) Inventor: Gerold Tebbe, Monte Carlo (MC)

Correspondence Address: FACTOR & PARTNERS, LLC, 1327 W. WASHINGTON BLVD., SUITE 5G/H, CHICAGO, IL, 60607, US

(21) Appl. No.: 10/097,437

(22) Filed: Mar. 14, 2002

(30) Foreign Application Priority Data
Mar. 14, 2001 (DE) 10112121.0

(51) Int. Cl. B32B 27/04; B32B 5/02; B32B 27/12; B32B 3/04; B32B 3/26

(52) U.S. Cl. 442/96; 428/320.2; 428/905; 428/130

(57) ABSTRACT

The invention relates to a folded fibrous material, e.g. a paper or fabric serviette, which, in the folded state, comprises microcapsules enclosed between two plies (12, 14, 16, 18) of the material, which microcapsules enclose a fragrance or an odor-neutralizing substance (26). The wall material of the microcapsules is connected non-interlockingly with the adjacent material plies (12, 14, 16, 18) optionally by a binder. Upon unfolding of the fibrous material, the microcapsules are destroyed, and a smell or an odor-neutralizing substance is released.

The invention relates to a fibrous material and to a method and a treatment liquid for the production thereof.

The micro-encapsulation technique is well known. In this technique, film-forming polymers are deposited on the material to be encapsulated. The microscopically small capsules may be dried virtually to a powder. In this way, food flavourings and perfumes for example may be converted into a dry composition, which cannot dry out and the contents of which are released when required by for example mechanical action.

Micro-encapsulation of fragrances is also known. For example, perfumes have been enclosed in microcapsules which are then applied to a page advertising the perfume, it being possible to release the perfume by rubbing with a hard object.

Microcapsules are also known for fragrances, odour-neutralising, skin-care or healing substances, which are rubbed on the skin and thereby release the contents. However, as with sprays, this has the disadvantage that the fragrances are not distributed uniformly over the entire body. Moreover, such conventional use of microcapsules is awkward in other items which are not normally subjected to rubbing.

It would be desirable to provide micro-encapsulation which allows a fragrance or a substance neutralising a bad odour to be released upon use of an article without special activity being necessary for this release.

This object of the invention is achieved by a fibrous material which is characterised in that, in the folded state, it comprises microcapsules enclosed between at least two plies of the material, which microcapsules enclose a fragrance, an odour-neutralising, healing or skin-care substance or mixtures of these substances and whose wall material is connected non-interlockingly with the adjacent material plies.

If the folded fibrous material according to the invention is unfolded, the microcapsules break, wherein they release a fragrance, an odour-neutralising substance, a skin-care substance or a healing substance.

A further development of the invention is characterised in that the microcapsules are connected with the adjacent material plies by a binder.

An advantageous connection is thus obtained between microcapsules and fibrous material.

A further development of the invention is characterised in that the microcapsules may be washed out.

This ensures that the used microcapsules may be removed from the fibrous material by washing out and that the material may be recharged with microcapsules.

A further development of the invention is characterised in that the wall material of the microcapsules and/or a binder, by which the microcapsules are connected with the fibrous material, is soluble or dispersible in water, at least in water containing detergent.

This also ensures that washing out of the used microcapsules and/or of the binder may be effected with water and optionally surfactant.

A further development of the invention is characterised in that it forms a paper or fabric serviette.

In this way, a serviette is obtained which automatically releases a fragrance when unfolded. This provides a nice start especially to celebratory meals.

A further development of the invention is characterised in that it forms an item of underwear or clothing or a part thereof.

This has the advantage that a smell is released at the same time as the item of clothing is unfolded. This reinforces the user's impression that he/she is putting on a new, clean item of clothing.

A method according to the invention for producing a fibrous material is characterised in that (a) a fibrous material is sprayed in the unfolded state with a fluid containing microcapsules, (b) the fibrous material is then folded immediately using slight pressure such that at least some of the microcapsules adhere to both plies thus placed one on top of the other, (c) liquid which may be present is caused to evaporate.

A further method for producing a fibrous material is characterised in that (a) a fibrous material in the unfolded state is provided with a binder layer (24a, 24b), (b) microcapsules (20) containing a fragrance or an odour-neutralising substance are applied to the binder and (c) the fibrous material is folded with the application of slight pressure, such that at least some of the microcapsules adhere to both binder layers placed one on top of the other.

These methods allow a material to be prepared very simply in such a way that microcapsules are located between individual plies of the fibrous material and stick to both superposed plies, such that they are broken open when the fibrous material is unfolded.

A treatment liquid according to the invention for use in such a method is characterised in that it comprises a binder applicable adhesively to the fibrous material, in which binder microcapsules containing fragrances or an odour-neutralising substance are dispersed.

When such a fluid containing microcapsules is used, the microcapsules are bound well to the fibrous material. Since the microcapsules containing the fragrance or an odour-neutralising substance are dispersed in the binder, a lastingly uniform distribution of the microcapsules in the binder is obtained.

A modified treatment liquid is characterised in that it is enclosed in a container together with a propellant gas which does not mix therewith.

In this way, even an end user may simply apply the finish to the fibrous material.

The fibrous material according to the invention may for example comprise paper, fabric also being possible. Fibrous material consisting of paper is usually a disposable item which is used only once, such as for example a paper serviette. In the case of fibrous material consisting of a fabric, the items are usually reusable, such as for example fabric serviettes or items of clothing.

The inside of the microcapsules generally consists of a liquid which releases a fragrance or has an odour-neutralising effect. However, it may also be a solid material which comprises an adsorbed liquid or gas which exudes a smell or neutralises an odour or evaporates directly (sublimation). The capsule contents may also have a skin-care or healing effect. The capsules may also contain mixtures of the above-mentioned substances or the microcapsules may comprise a mixture of microcapsules, each kind containing only one substance.

Breaking of the microcapsules causes their contents to be released.

The wall of the microcapsules may be selected from various materials which on the one hand may be connected directly or via a binder with the fibrous material and on the other hand break when exposed to mechanical loads, such as for example silicone elastomers, polyurethanes, grades of nitrile rubber, grades of chloroprene rubber, polyvinyl alcohols, silicones, ethylene/vinyl acetate polymers, acrylic resins and urea-aldehyde polymer. The microcapsules may be produced according to the method in Example 10 of U.S. Pat. No. 3 516 941 A.

The sizes of the microcapsules amount in general to approximately 2-300 μm, preferably approximately 4-80 μm and in particular approximately 15-25 μm. By means of the selected microcapsule size, it is possible to control how hard or easy the capsules are to break when the two fibrous material plies with which they are connected are pulled apart.

If a binder is used to connect the microcapsules to the fibre plies, it may be selected from a wide variety of binders, such as polyurethanes, polyacrylates, polyvinyl resins (e.g. polyvinyl alcohol, polyvinyl chloride), polyamides, polyesters, polyolefins, starches, gum arabic, gelatin, cellulose and silicone rubber. For use with textile materials, it is preferable to select from these binders those which are soluble or dispersible in water and optionally surfactant.

All in all, the above-described materials are selected such that the intrinsic cohesion of the microcapsules is weaker than the adhesion thereof to the fibrous material or the binder and that the adhesion of the binder to the fibrous material is stronger than the intrinsic cohesion of the binder.

The invention is explained in more detail below with the aid of exemplary embodiments and with reference to the drawings, in which:

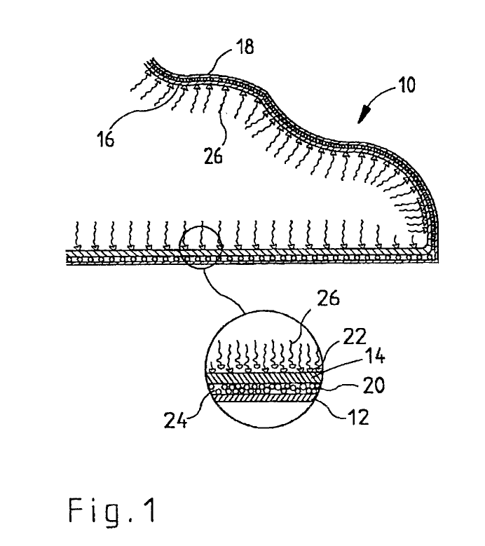

FIG. 1: shows a section through part of a four-ply material, in which composite layers of a binder and microcapsules, which contain a fragrance, are located between the individual plies of material, shown in the partially unfolded state;

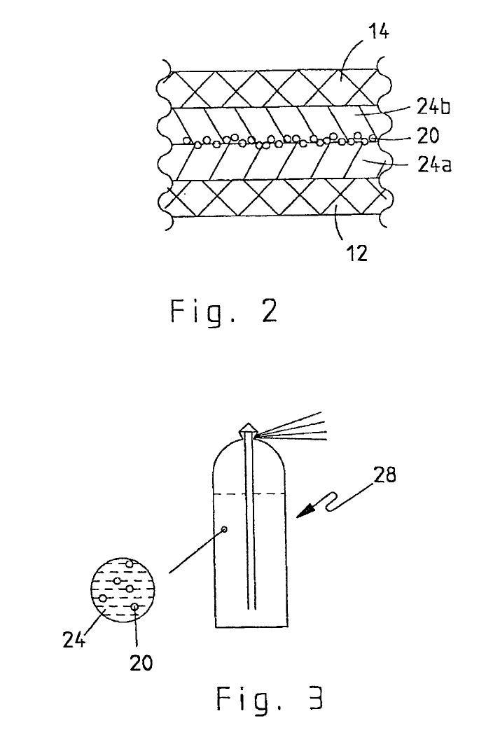

FIG. 2: shows a section through a two-ply material, in which microcapsules are located between binder layers connected with the material plies; and

FIG. 3: shows a spray canister, which contains a dispersion of microspheres and binder and serves to produce composite layers of binder and microcapsules on fibrous materials.

FIG. 1 shows four plies of a fibrous material, wherein in each case two plies, namely the plies 12 and 14 and the plies 16 and 18 are folded one on top of the other. Between the plies 12, 14 and 16, 18 there are located microcapsules, which are connected non-interlockingly with both in each case superposed plies.

The connection between the microcapsules and connection of the microcapsules to the fibrous material are preferably effected by a binder 24. The microcapsules between the plies 14 and 16 originally also adhered in the undamaged state to both plies. By separating the plies 14 and 16, the microcapsules have been damaged, whereby their contents, a fragrance or an odour-neutralising substance, have been released, as indicated by wavy lines 26.

In the case of the above-described fibrous material, which may constitute a folded serviette for example, the fragrances, odour-neutralising substances, skin-care substances or healing substances contained in the microcapsules 20 are kept together until the fibrous plies are folded open. The contents of the capsules are then released areally.

The fibrous plies may also comprise superposed plies of an item of clothing. Thus, for example, handkerchiefs may be sprayed after washing and shortly before folding with a liquid which comprises a binder and microcapsules dispersed therein containing a fragrance. The binder may comprise rice starch, for example. This binder is washed out with the microcapsule residues when the handkerchief is next washed. If the handkerchief is folded up after spraying, the microcapsules are then connected with two superposed plies of the handkerchief via the dried rice starch. Upon folding open of the handkerchief, the microcapsules are destroyed mechanically, since their capsule material is selected such that the mechanical strength of the microcapsules is less than the strength of the connection between microcapsule wall material and the fabric of the handkerchief provided by the rice starch binder layer located therebetween.

Other items of underwear or clothing may likewise be sprayed with a liquid containing microcapsules, preferably by actuating a spray. The smell escaping upon unfolding gives the user a reinforced sense that the item of underwear or clothing he/she is at that moment putting on is freshly washed.

In the case of the modified exemplary embodiment according to FIG. 2, the microcapsules 20 are enclosed between two binder layers 24a, 24b, which are carried by the ply 12 and the ply 14 respectively. The binder layers 24a and 24b were initially a continuous binder layer, which was applied (e.g. sprayed) onto a continuous material ply before the plies 12, 14 were positioned one on top of the other. The microspheres 20 were likewise applied, e.g. sprinkled or sifted, onto this originally single, continuous binder layer, while the plies 12, 14 were still unfolded.

The originally continuous ply with the originally continuous binder layer and the layer of microcapsules located thereover was then folded, so connecting the microcapsules with the plies 12, 14 via the two binder layers 24a, 24b.

If the two plies 12, 14 are pulled apart, the now internal microcapsule layer constitutes a dividing surface and the binder layers 24a and 24b separate, so destroying the microcapsules 20. A fragrance or an odour-neutralising substance located inside the microcapsules 20 is thus released.

The fragrance or odour-neutralising material enclosed in the microcapsules may also comprise a solid material, which sublimates after destruction of the microcapsule wall.

It goes without saying that the superposed plies of fibrous material may be coated with binder and microcapsules over the entire surface area or only over parts of the contact surface thereof. In this way, the force necessary to unfold the plies and the intensity of the smell escaping upon unfolding may be regulated.

If the fibrous material is a textile material, a binder is preferably used which dissolves upon washing of the textile material. In this way, the residues of the microcapsule walls still clinging to the plies are dissolved away upon washing of the textile material.

If desired, the microcapsule material itself may additionally be so selected that it dissolves upon washing.

For some instances of application, it is also sufficient to simply sprinkle the microcapsules onto the surface of the fibrous material immediately after they are produced, while the capsule walls are still tacky and before the plies of the fibrous material are folded one on top of the other.

In the case of items of underwear or clothing which are re-used frequently, the user may be provided with a finishing liquid with which he or she may him- or herself produce binder/microcapsule composite layers, as explained above with reference to FIGS. 1 and 2.

According to FIG. 3, a spray canister 28 contains an aqueous solution of a binder (for instance rice starch) and microcapsules 20. The spray canister 28 may be pressurised by a propellant gas or comprise a pump mechanism, as is conventional with spray canisters.

1. A folded fibrous material, characterised in that, in the folded state, it comprises microcapsules (20) enclosed between at least two plies of the material, which microcapsules enclose a fragrance, an odour-neutralising, healing or skin-care substance (23) or mixtures of these substances and whose wall material is connected non-interlockingly with the adjacent material plies (12, 14; 16, 18).

2. A fibrous material according to claim 1, characterised in that the microcapsules (20) are connected with the adjacent material plies (12, 14; 16, 18) by a binder (24).

3. A fibrous material according to claim 1, characterised in that the microcapsules (20, 22) may be washed out.

4. A fibrous material according to claim 3, characterised in that the wall material of the microcapsules and/or a binder (24), by which the microcapsules (20) are connected with the fibrous material, is soluble or dispersible in water, at least in water containing detergent.

5. A fibrous material according to claim 1, characterised in that it forms a paper or fabric serviette.

6. A fibrous material according to claim 1, characterised in that it forms an item of underwear or clothing or a part thereof.

7. A method of producing a fibrous material according to claim 1, characterised in that (a) a fibrous material is sprayed in the unfolded state with a fluid containing microcapsules, (b) the fibrous material is then folded immediately using slight pressure such that at least some of the microcapsules adhere to both plies thus placed one on top of the other, (c) liquid which may be present is caused to evaporate.

8. A method of producing a fibrous material according to claim 1, characterised in that (a) a fibrous material in the unfolded state is provided with a binder layer (24a, 24b), (b) microcapsules (20) containing a fragrance or an odour-neutralising substance are applied to the binder and (c) the fibrous material is folded with the application of slight pressure, such that at least some of the microcapsules adhere to both binder layers placed one on top of the other.

9. A treatment liquid for use in the method according to claim 7, characterised in that it comprises a binder applicable adhesively to the fibrous material, in which binder microcapsules containing fragrances or an odour-neutralising substance are dispersed.

10. A treatment liquid for use in the method according to claim 9, characterised in that it is enclosed in a container together with a propellant gas which does not mix therewith.
